(19) United States
(12) Patent Application Publication
(10) Pub. No.: US 2014/0318093 A1
(43) Pub. Date: Oct. 30, 2014

(54) CERAMIC FILTER FOR EXHAUST GAS PARTICULATES HAVING ASYMMETRIC CHANNELS

(71) Applicant: Dow Global Technologies LLC, Midland, MI (US)

(72) Inventor: Jeremy Patt, Midland, MI (US)

(21) Appl. No.: 14/362,485

(22) PCT Filed: Jan. 18, 2013
(86) PCT No.: PCT/US2013/022047

§ 371 Date: Jun. 3, 2014

Related U.S. Application Data
(60) Provisional application No. 61/588,894, filed on Jan. 20, 2012.

(51) Int. Cl. B01D 46/24; F01N 3/022

(52) U.S. Cl. CPC B01D 46/2418; F01N 3/0222; F01N 2570/00; B01D 2046/2492
USPC 55/529

(57) ABSTRACT

The present invention allows tailoring the filter design for optimal engine performance by providing the desirable ratio of greater than one, without necessitating an increase of the overall filter volume and without decreasing filter efficiency. Moreover, the present invention allows an increase in the ratio, while at the same time reducing, the overall filter volume, or in other words, providing smaller filter volume for a given ratio. In addition, the present invention preserves Identical inlet channel surface and outlet channel surface areas, while having the ratio value of greater than one. These advantages achieved by having unique geometry of the cross-sectional area of the inlet and outlet channels, where both channels have the same perimeter length in every embodiment of the invention. The present invention provides continuous variability in the selection of the ratio values which is not constricted by the geometry or other consideration, thereby better addressing the specific needs of various engines, and allowing fine tuning of optimal balance between the high soot capacity and low pressure drop requirements.

### FIELD OF THE INVENTION

The present invention generally relates to a wall flow honeycomb filter. In particular, the filler relates to an improved structure of the channels in the honeycomb-filter to provide a lower degree of pressure drop at high soot or ash loadings without increasing the total volume of the filter.

### BACKGROUND OF THE INVENTION

Diesel engines emit a particulate matter and typical toxic engine exhaust gases in their exhaust stream, and part of it is uncombusted particulate master, such as ash and soot. The emitted particulate matter is harmful to the environment and humans, and therefore regulations have been enacted curbing the amount of particulate matter permitted to be emitted. Typical engines have an exhaust system that includes a filtration apparatus for filtering out particulate matter from the exhaust stream, so that the emissions comply with environmental regulations. Moreover, to meet recent fuel economy standards, car makers must reduce fuel consumption, which consequently requires a general reduction in a weight of a car. Thus, engineers strive to reduce the weight and the size of car systems, including filtration apparatus. To meet these challenges, various systems of diesel particulate filters have been proposed.

Typically diesel particulate fitters are made of porous ceramics wherein the filter is a wall flow filter. Wall flow filters typically have a thin porous walled ceramic honeycomb structure, in which interconnecting thro porous walls define flow channels that are disposed mutually parallel to one another. The channels extend longitudinally through the structure and define two opposing open end faces. In the direction perpendicular to the walls the diesel particulate filters generally demonstrate a consistent cross-sectional matrix-like geometry of channels' grid. When the cross-sectional areas of the inlet and outlet channels are identical, as illustrated for example in FIG. 1, it is usually manifested in symmetrical cross-sectional matrix. At each end face, the ends of alternate channels are plugged or sealed in a checker-board pattern, as depicted in an exemplary fashion in FIG. 1. The pattern is reversed at either end face so that each channel of the structure is closed at only one end face.

An exhaust emission or the like is introduced to the wall flow honeycomb filter through the “inlet” end face: of the filter structure, such that the exhaust emissions cannot pass through the end of the plugged or sealed channels, hereinafter referred to as “inlet” channels. The channel that are plugged/sealed at the inlet side of the filter structure are “outlet” channels, hereinafter referred to as “outlet” channels. The exhaust stream flows from the islet face end, through the islet channels, and to discharge purified exhaust from the opposing end, the outlet end face, through the outlet channels. In general, inlet channels share thin porous walls with adjoining channels that arc usually outlet channels, and the filtration occurs through those walls which are shared in common between adjoining inlet and outlet channels. The captured soot is collected on the surfaces defining the interior of the inlet channels and/or within the pores of thin porous walls.

One of the current challenges arises because as the amount of the captured soot accumulated on the walls of the inlet channels increases, the thickness of the build-up interferes with gas flow. The presence of the accumulated soot causes an increase in the pressure drop across the filter and the back pressure against the engine, reducing the output and increasing the fuel consumption of the engine. When the back pressure or pressure drop exceeds its maximum predetermined value, regeneration or replacement of the filter is required. Another challenge is that in order to comply with environmental regulations, more effective or bigger filters are Required, which add to the weight of the car and/or take more space, thus, making it harder to comply with fuel economy regulations which favor production of a lighter car. Therefore, there is a need to find a solution that satisfies both requirements.

Currently, attempts have beers made to address some of these problems, such as providing filters that maintain desirable flow rate and provide higher soot storage capacity. For example U.S. Pat. No. 4,276,071, U.S. Patent Application Publication 2005/0,016,141 and 2005/0076627 filters have higher filter surface area due to different symmetrical and asymmetrical cross-sectional matrix geometries. U.S. Pat. Nos. 4,417,908 and 4,420,316 provide higher filter surface area of the inlet channels by employing different plugging patterns. U.S. Pat. No. 4,643,749 and 7,247,184 disclose filter structures with Improved flow rate through the inlet channels due to the variation of wall thickness.

There continues to be a need for a particulate wall flow honeycomb filter that provides adequate filtration efficiency while minimizing the penalty on fuel efficiency. Filters reduce fuel efficiency by increasing back pressure on the engine, requiring extra fuel for regeneration, and adding additional mass and size to the vehicle. Automotive makers desire to minimize pressure drop and regeneration frequency while balancing the competing desire to minimize the packing size and weight. Each application is unique because different engine technologies and duty cycles influence the rate of soot and ash accumulation as well as the flow rates of exhaust gas that need to be filtered. In particular, there is a demand for wall flow filters with a lower degree of pressure drop at higher soot and ash loadings. Automotive manufacturers desire a particulate wall How filter design where the filter geometry cm be selected to provide a longer regeneration frequency for a selected packing size and a selected maximum allowable pressure drop. Furthermore, it would be even more desirable to provide a wall flow filter where the honeycomb geometry -could be tinted in an analog fashion, and the specific geometry of the filter eon id be selected to optimize a continuous relationship between pressure drop performance and regeneration frequency for a given filter size.

### SUMMARY OF THE INVENTION

One possible embodiment includes: a honeycomb filter, comprising a plurality of internal walls defining a plurality of inlet channels and a plurality of outlet channels, wherein: all the internal walls are disposed between the inlet and outlet channels, the internal walls define the cross-sectional perimeters of the inlet channel have a shape of a polygon and an inlet channel perimeter length, the cross-sectional perimeters of each of the outlet channel have a shape of a polygon and an outlet perimeter length; the outlet channels have two pairs of internal walls forming two opposite acute angles; and wherein a ratio of the cross sectional area of the inlet channels defined by the cross-sectional perimeters of the inlet channels to the cross-sectional area of the outlet channels defined by the cross-sectional perimeters of the outlet channels is greater than 1.0. In one embodiment, the perimeter length of the inlet channel is equal to the perimeter length of the outlet channel.

In one embodiment, the cross-sectional perimeter of the inlet channel has four sides equal in length, and four angles equal to about 90 degrees. Preferably, the acute angle of the cross-sectional perimeter of the outlet channel is less than 90 degrees and greater than about 50 degrees. In another embodiment, the honeycomb filter of the invention includes filters wherein all the internal, walls thicknesses are essentially substantially uniform and substantially identical.

In another embodiment, the honeycomb filter has inlet channels and outlet channels arranged such that all the internal walls of the inlet channels are shared in common with the adjoining outlet channels; the ratio of the cross-sectional area of the inlet channels to the cross-sectional area of the outlet channels is less than about 2.0. Another possible embodiment of the present invention Includes the honeycomb filter wherein the ratio of the surface area of the inlet channels to the surface area of the outlet channels is about 1.0. Another possible embodiment includes the honeycomb filter wherein the length of the internal walls of the inlet channels and the length of the internal, walls of the outlet channels is essentially of the same dimension in the longitudinal direction from one end face to another end face. An advantage of the honeycomb filter described herein is that the size (i.e. the length, diameter, cross sectional area, or a combination thereof) may be reduced without sacrificing soot storage capacity.

In another embodiment, the present invention includes the honeycomb filter wherein a volume of the inlet channels is defined as the cross sectional area of the inlet channels multiplied by the length of the internal walls of the inlet channels in the longitudinal direction; a volume of the outlet channels is defined as the cross section area of the outlet channels multiplied by the length of the internal walls of the outlet channels in the longitudinal direction; a relative total volume of the filter is defined as a ratio of V and Vₘₐₓ, wherein (V) being a total volume defined by a sum of the volumes of all the inlet channels and the volumes of all the outlet channels, (Vₘₐₓ) having a maximum value of the sum of the volumes of all the inlet channels and the maximum volumes of all the outlet channels; and wherein the ratio is less than 1.0.

The present invention as discussed herein may be used in any combustion engine. The present invention allows tailoring the filter design for optimal engine performance by utilizing asymmetrical cross-sectional matrix geometry resulting in the ratio of the cross-sectional areas of the inlet channel to the outlet channel greater than one. When the ratio is greater than one, it allows maintaining desirable flow rate and low pressure drop for longer periods of time. The present invention provides ratio greater than one without necessitating as increase of the overall filter volume and without decreasing filter soot storage capacity. Moreover, the present invention allows an increase in the ratio while at the same time reducing the overall filter volume or, in other words, providing smaller filter volume for a given soot storage capacity. In addition, the present invention preserves identical inlet channel surface and outlet channel surface areas, while having the ratio value of greater than one. These advantages are achieved by having unique geometry of the cross-sectional area of the inlet and outlet channels, where both channels have, the same perimeter length in every embodiment of the invention. The present invention provides continuous variability in the selection of the ratio values which is not constricted by the geometry or other consideration, thereby better addressing the specific needs of various engines, and allowing fine tuning of optimal balance between the high soot capacity and low pressure drop requirements. Particularly, the present invention may be used in a diesel engine and it may be cleanable. Particulate filter systems can be installed in or on any combustion engine for stationary or mobile applications. For example, particulate filter systems may be installed in cars, trucks, boats, heavy machinery, generators, or any other motor that uses fossil fuels to generate power.

### BRIEF DESCRIPTION OF THE DRAWINGS

FIG. 1 illustrates a schematic perspective view showing an exemplary honeycomb channels structure in a wall flow filter with symmetric geometry.

FIG. 2 illustrates an exemplary pictorial of a schematic fragmentary perspective view of one of the embodiments of a wall flow filter.

FIG. 3 illustrates an exemplary pictorial configuration of a schematic fragmentary cross-sectional view of FIG. 2.

FIG. 4 illustrates an enlarged cut-out of FIG. 3.

FIG. 5 illustrates an exemplary schematic cross-sectional view showing one possible configuration of the matrix geometry of a wall flow filter.

FIG. 6 illustrates an exemplary schematic cross-sectional view showing another possible configuration of the matrix geometry of a wall flow filter.

FIG. 7 illustrates results of the calculations of the ratio of the cross-sectional area of the inlet channel to the cross-sectional area of the outlet channel that correspond to different values of the acute angle (numerical results are summarized in Table 1).

FIG. 8 illustrates results of the calculations of the values of the relative filter volume that correspond to different, values of the acute angle (numerical results are summarized in Table 1).

### DETAILED DESCRIPTION OF THE INTENTION

The explanations and illustrations presented herein are intended to acquaint others skilled, in the art with the invention, its principles, and its practical application. Those skilled in the art may adapt and apply the invention in its numerous forms, as may be best suited to the requirements of a particular use. The specific embodiments of the present invention as set forth are not intended as being exhaustive or limiting of the invention. The scope of the invention should be determined with reference to the appended claims, along with the full scope of equivalents to which such claims are entitled. The disclosures of all articles and references. including patent applications and publications, are incorporated by reference for all purposes,

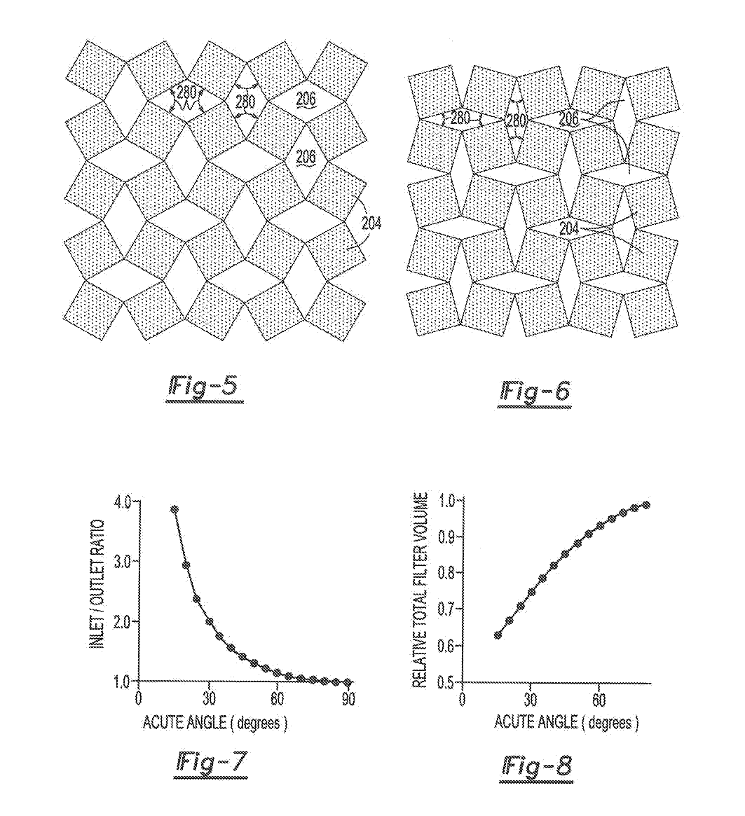

The present invention is predicated upon providing an improved ceramic wall flow honeycomb filter, useful as a diesel particulate filter, with an improved soot and ash. storage capacity and identical inlet and outlet channel surface areas without necessitating an increase of the overall filter volume and without increasing the average pressure drop during operation, hi the honeycomb filter of the present invention, the effective flow area of the inlet channel is greater than the effective flow area of the outlet channel, thus providing a lower degree of a pressure drop at higher soot and ash loadings. This is manifested is asymmetrical cross-sectional matrix geometries of rise inlet and outlet channels, as exemplified in FIGS. 5 and 6. All the proposed geometries of the present invention retain common advantages, such as using almost 100% of the walls area as a flow-through filter surface and providing identical surface area of the inlet and the outlet channels. Concurrently, the invention also allows reduction of an overall volume of the filter without affecting-soot storage capacity or average pressure drop.

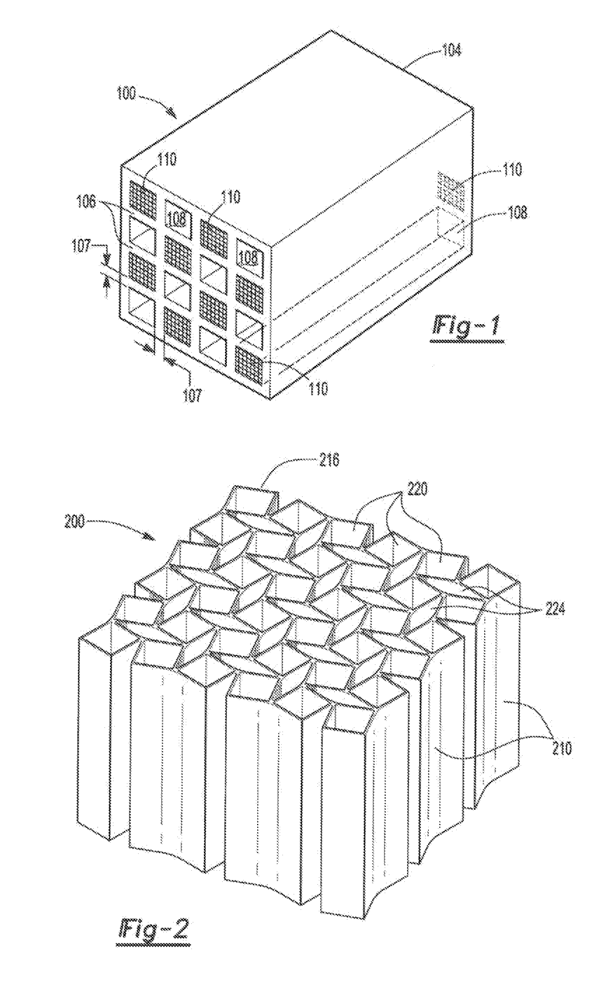

The wall flow filter may have a shape and a size of the ultimate desired ceramic body, such that it can be utilised as a wall flow filter. A wall flow filter exhibits a cross-sectional shape which is consistent for all planes parallel to the two opposing end faces. The cross-sectional shape can be any shape which is suitable for the intended use and may be irregular or may be of any known shape, such as round, oval or polygonal. The wall flow filter or its segments comprises a honeycomb structure formed by a plurality of internal thin porous intersecting walls which define a plurality of channels extending longitudinally and mutually parallel through the body of the filter between two opposing end laces. At each end face, the ends of alternate channels may be plugged or sealed in a checker-board pattern, as shown in FIG. 1. The pattern is reversed at either end face so that each channel of the structure is closed at only one end face. The ends of the channels may be closed, sealed or plugged with any filler material and in any manner compatible with the material of the thin walk and with the. operation of the filter. The plugs may be the same or a different ceramic than the honeycomb as well as may simply be the partition wails of the honeycomb pinched together to close off a channel.

The wall flow filter mm include an inlet end face and an outlet end face. Inside the wall flow filter the internal thin porous walls allow a fluid, for example, an exhaust emission or the like to be introduced through the inlet end face, which flows through the inlet channels, and discharged from the outlet end face, through the outlet channels, without at least a portion of the particulate matter contained in the exhaust. The inlet channels are plugged/sealed at the outlet end face of the filter structure, such that the fluid cannot pass through the end of the plugged inlet channels. The number of channels is not limited. Preferably, the number of the inlet channels may be set to be substantially equal to the number of the outlet channels in the filter. The outlet channels are plugged/sealed at the opposing side of the filter structure, e.g. on the inlet end face. Thus, the fluid passes through the thin porous walls which serve as a particulate filter. Filter soot storage capacity is the amount of the particulate matter that the filter can hold while still providing a maximum acceptable back pressure. The inlet and the outlet channels may include a length. The length of a channel is generally the distance between the opposing end faces of the filter in the longitudinal direction. The inlet and the outlet channels may have substantially the same length throughout the filter. The wall flow filter may have a cell density which is not especially limited.

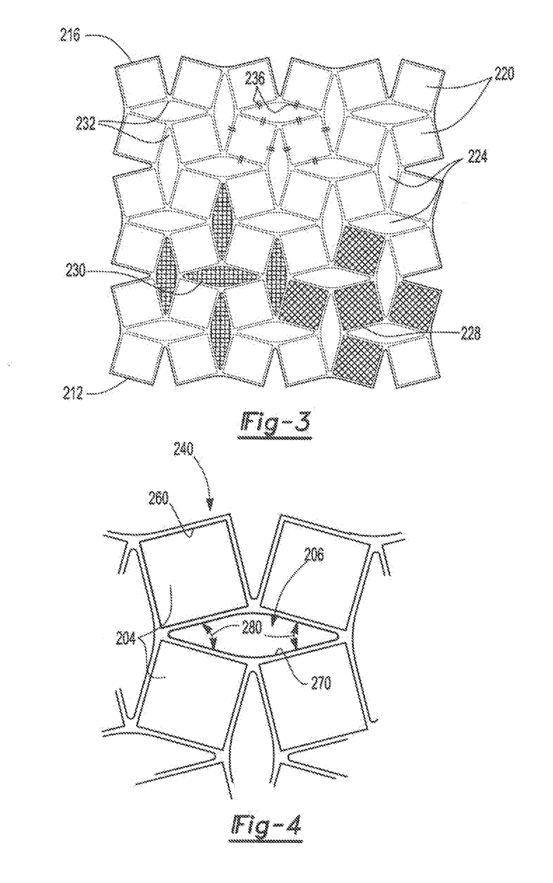

The Internal thin wails are porous. The porosity of the internal walls may be variable. The porosity may be such that the sufficient filtering of a particulate matter contained in the fluid is achieved and a structural integrity of the filter is not compromised. The porosity may be such that the sufficient filtering of the particulate matter from the fluid, for example, diesel exhaust is achieved. The internal thin porous walls may have a thickness. The thickness of the internal thin porous walls is not especially limited The thickness of the internal walls may be preferably less than about 1.0 mm and more preferably less than about 0.5 mm. The thickness of the internal walls may be preferably greater than about 0.1 mm and even more preferably greater than 0.15 mm. Preferably, the thickness of the internal thin porous walls may be substantially uniform throughout the filter, the wall thickness, preferably exhibits a standard deviation of about 20 percent or less. The area of the internal thin porous walls may define the internal surface of the inlet and outlet channels. The internal thin porous wails may form corners. The corners may include fillets or chamfers. The fillets may have a radius. The radius of the fillets may set to be such that the thickness of the walls may be uniform throughout the filter. In general, each inlet channel may have four adjacent inlet channels and each outlet channel may have four adjacent outlet channels, as exemplified in FIG. 3. In all the embodiments, the thickness of the corners between the points of contact between any two adjacent inlet channels may be substantially equal to the thickness of the corners between the points of contact between any two adjacent outlet channels. Preferably, the corners of the polygonal cross-sections of any two the adjacent inlet channels may be the only points of contact between these channels. Preferably, the corners of the polygonal cross-sections of any two adjacent outlet channels may be the only points of contact between these channels. Preferably, all the inlet channels may share wails in common with the outlet channels, except at the points of contact of any two adjacent inlet channels and any two adjacent outlet channels. The points of contact of any two adjacent inlet channels and any two adjacent outlet channels may be corners. In all embodiments, all the inlet channels may share walls in common with the outlet channels except in the points of contact. Preferably, in all the embodiments, all the non-contacting portions of the wall areas may be effective for filtration process. In the wall flow fibers the fluid stream is introduced through the inlet channels and forced to flow through the outlet channels, passing through the internal thin porous walls, leaving the particulate matter on or within the walls. In general, the filtration occurs mainly through the thin walls shared in common between adjoining inlet and outlet channels. Therefore, in general, the internal walls may be more effectively utilized when maximum amount of walls are shared between the inlet and the outlet channels, in comparison to a filter where some of the inlet thin porous channels have shared walls with other inlet channels. Hence, all the embodiments of the present invention discussed above facilitate high filter efficiency by allowing full utilization of the wall surfaces.

The wall flow filter may include the inlet and the outlet channels that may form a cross-sectional perimeter in the direction perpendicular to the walls. Preferably, the length of the perimeter of the inlet channel area may be equal to the length of the perimeter of the outlet channel area. Thus, the ratio of the length of the perimeter of the inlet channel area to the length of the perimeter of the outlet channel area may be equal to about 1.0. The cross-sectional perimeter of the inlet channels may have a predetermined shape. The cross-sectional perimeter of the outlet channels may have a predetermined shape. The cross-sectional perimeter of the inlet and outlet end feces may show a predetermined matrix-like geometry constituted by the repetition of the cross-sectional perimeter shapes of the inlet and the outlet channels. The predetermined matrix-tike geometry may be consistent throughout the filter. The shape of the cross-sectional perimeter of the inlet channel may be different from the shape of the cross-sectional perimeter of the outlet channel. Preferably, the cross-sectional geometry of the inlet and the outlet channels areas may have a polygonal shape. Preferably, the polygonal shape is four-sided. Preferably, the polygonal shape of the inlet channels may be different from the polygonal shape of the outlet channels. The polygonal, shape may include corners.

The polygonal shape of the cross-sectional perimeter of the inlet channels may include four sides and four angles. More preferably, the four angles of the polygon of the cross-sectional perimeter of inlet channels may be the same size and measure in degrees. More preferably, each of the four angles of the polygon of the cross-sectional perimeter of inlet channels may be about 90 degrees. Preferably, the opposite sides of the polygon of the cross-sectional perimeter of inlet channels may be equal in length. The opposite sides may be parallel. Preferably, the polygonal shape of the cross-sectional perimeter of inlet channels may be a rectangle. More preferably, the polygonal shape of the cross-sectional perimeter of inlet channels may be a square. Generally, throughout the filter, substantially all the inlet channels have the uniform polygonal shape discussed above.

The polygonal shape of the cross-sectional perimeter of outlet channel may have four sides and four angles. More preferably, two opposite angles of the polygon of the cross-sectional perimeter of outlet channels may have the same size and measure in degrees, and each may be greater than 90 degrees, and the other two opposite angles may have the same size and measure, and each may be less than 90 degrees. The angles that are less than 90 degrees, hereinafter called “acute angles”. More preferably, the acute angle described above is about 30 degrees or greater, 40 degrees or greater, about 50 degrees or greater, or about 60 degrees or greater. Preferably, the acute angle is less than 90 degrees, or about degrees or less, and about 80 degrees or less. Preferably, the length of the perimeter of the inlet and outlet channels may be independent of the acute angle measure in degrees. Preferably, the opposite sides, of the polygon of the cross-sectional perimeter of the outlet, channels may be equal in length. The opposite sides of the polygon of the cross-sectional perimeter of outlet channels may be parallel to each other. More preferably, the polygonal shape of the cross-sectional perimeter of outlet channels may be a parallelogram. More preferably, the polygonal shape of the cross-sectional perimeter of the outlet channels may be a rhombus.

The inlet and the outlet channels may have cross-sectional areas defined by their corresponding cross-sectional perimeters. The cross-sectional areas of the inlet and the outlet channels may define a ratio of the cross-sectional area of the inlet channel area to the outlet channel area. The cross-sectional area of the inlet channels may be independent of the acute angle measure in degrees. The cross-sectional area of the outlet channels may depend on the acute angle measured in degrees. The ratio of the cross-sectional area of the inlet channel to cross-sectional area of the outlet channel preferably may be greater than about 1.0, more preferably, about 2.0 or less, even more preferably about 1.6 or less, even more -preferably about 1.4 or less, most preferably about 1.2 or less. These values of the ratio result in a larger effective flow area of the inlet channel which allow lower pressure drop for longer periods of time during soot and ash loading. The pressure drop is the difference between the fluid pressure upstream and downstream, the difference caused by the presence of the filter and particulates thereon. Flow rate is the volume of fluid per unit time that passes through the filter with the collected particulates thereon. Hence, the flow rate is greatly affected by the amount of collected particulates. Filter structure wherein area, of the inlet channels is larger than the area of the outlet channels provides the following advantages sustaining desirable flow rate while providing lower pressure drop for longer periods of time during soot and ash accumulation.

The inlet and the outlet channels may include an internal surface area. The surface area of the inlet/outlet channels may be defined as a product of the cross-sectional perimeter of the inlet/outlet channels and the length of the inlet/outlet channels. The surface area of the inlet channels may be identical to the surface area of the outlet channels throughout the filter. The surface area of the inlet and of the outlet channels may be independent of the acute angle measure in degrees in all the embodiments. This configuration has an advantage of preserving sufficiently large soot storage capacity, which is the amount of soot that the filter can hold while still providing a maximum acceptable pressure drop. In the wall flow filter substantially all the soot is accumulated on or within the wails defining the interior of the inlet channels. The wall flow filter typically maps particles in two basic modes at the beginning of the cycle the particles are captured in the filter pores of the inlet channels, and at longer times the particles form a “cake” on. which particles are trapped. Eventually, the “cake” build-up reaches a thickness that interferes with gas flow through the inlet channels by decreasing the effective flow area of the inlet channels. The pressure drop across the filter is the difference between the gas pressure upstream and downstream caused by the presence of the filter and accumulated soot thereon, and is also dependent on the flow rate. The equal perimeters of the inlet and outlet channels providing equal, surface area of the inlet and outlet channels also allow a longer filter operating time because the soot storage capacity of the filter is sufficiently high. Another advantage of the preservation of the same surface area of the inlet and outlet channels, is that it provides lower hack pressure, i.e. the gas pressure upstream which depends on the downstream pressure and the pressure drop. The more soot accumulates on the surface of the inlet channels, the more back pressure increases, increasing the fuel consumption of the combustion engine. When back pressure exceeds a predetermined value, regeneration or replacement of the filter is required.

The wall flow filter may include a total volume. The total volume comprises a volume of the inlet channels and a volume of the outlet channels and is designated V. The variation in the volume of the outlet channels may be related to the variation of the value of the acute angles of the cross-sectional perimeter of the outlet channels. The volume of the outlet channels may have a maximum value. The volume of the outlet channels may have the maximum value when all the angles of the outlet cross-sectional perimeter are about 90 degrees. The wall flow filter may have a maximum value of the total volume. The maximum value of the total volume of the filter is a sum of the volume of the inlet channels and the maximum value of the volume of the outlet channels. The maximum value of the total volume of the wall flow filter is designated Vₘₐₓ. The wall flow filter may include a relative total volume. The relative total volume of the wall flow filter is a ratio of the sum of the inlet and the outlet channel, volumes (V) to the maximum value of the sum of the inlet and the outlet channel volumes (Vₘₐₓ). The relative total volume of the wall flow filter may be related to the value of the acute angles of the cross-sectional perimeter of the outlet channels, for example, as the measure of the acute angles of the outlet channels is decreased, the volume of the outlet channels decreases, and as a result, the total volume of the filter (V) decreases as well. Hence, the relative total volume of the filter, V/Vₘₐₓ is decreased as well. Preferably, the relative total filter volume may be less than 1.0, about 0.95 or less, more preferably about 0.90 or less. Therefore, this filter structure may provide smaller filter volume for a given soot storage capacity, because the surface area of the inlet and of the outlet channels may be independent of the acute angle measure in degrees in all the embodiments. The filter structure may provide improved pressure drop performance, e.g. cross-sectional ratio greater than about 1.0, while reducing the overall filter volume and maintaining the same high filter storage capacity. Furthermore, a reduction in the size of the wall flow filter may provide more space in. the exhaust system for the inclusion of other emission components without reducing the soot storage capacity of the diesel particulate filter, without reducing the efficiency of the exhaust system, reducing the system cost of the exhaust system, providing smaller packaging space, or a combination thereof.

The present teachings improve or maintain pressure drop performance of the wall flow filter by providing larger effective flow area of the inlet channel and increasing soot and ash storage capacity. Furthermore, the wall flow filter maybe easily formed such that the acute angle may have any measure of the angle within the range discussed above. Hence, the measure of the acute angle of the outlet channel may be changed to a small: extent, causing desirable smooth variation of the cross-sectional ratio, thus affecting a flow rate by a certain extent. Thus, continuous variability in the selection of the ratio value corresponds to continuous variability in a selection of the pressure drop performance that may be adjusted for the specific needs of various engines. A small change in the measure of the acute angle of the outlet channel may cause desirable smooth variation in the relative filter volume as well, as discussed above. The measure of the acute angle of the outlet channel is not constricted by the geometry or other consideration, allowing fine tuning of optimal balance between the low pressure drop, regeneration frequency, and lower ear weight requirements. In general, the present invention may be used to increase the storage capacity of the filter, downsize the volume of the filter, increase the period between filter regenerations, or a combination thereof. The ceramic parts may be used in any applications in which it is useful to have diesel particulate filters and flow channel catalyst branches (catalytic converter).

A summary of calculation results for a range of values of acute angle (Φ) is shown in Table 1.

TABLE 1

| | Ratio of inlet | |
|---|---|---|
| Φ—acute angle | to outlet | Relative |
| in degrees | cross-sectional areas | Volume |
| 15 | 3.86 | 0.63 |
| 20 | 2.92 | 0.67 |
| 25 | 2.37 | 0.71 |
| 30 | 2.00 | 0.75 |
| 35 | 1.74 | 0.79 |
| 40 | 1.56 | 0.82 |
| 45 | 1.41 | 0.85 |
| 50 | 1.31 | 0.88 |
| 55 | 1.22 | 0.91 |
| 60 | 1.15 | 0.93 |
| 65 | 1.10 | 0.95 |
| 70 | 1.06 | 0.97 |
| 75 | 1.04 | 0.98 |
| 80 | 1.02 | 0.99 |
| 85 | 1.00 | 1.00 |
| 90 | 1.00 | 1.00 |

The wall flow honeycomb filter may be formed by any suitable process such as those known in the art, the most common being extrusion of a ceramic plastic mass comprised of ceramic particulates and extrusion additives, surfactants, organic binders and liquids to make the mass plastic and to bond the particulates. The extruded honeycomb structure is then typically dried of carrier liquids, and organic additives such as lubricants, binders, porogens and surfactants are removed by heating. Further heating causes the ceramic particulates to fuse or sinter together or create new particulates that subsequently fuse together, in the case of mullite the ceramic bodies are heated in SiF₄ to form mullite. Such methods are described by numerous patents and open literature with the following merely being a small representative sample of U.S. Pat. Nos. 4,329,162; 4,741,792; 4,001,028; 4,162,283; 3,899,326; 4,786,542; 4,837,943 and 5,538,681, all incorporated herein by reference.

The segments of the honeycomb-structure of the wall flow filter may be any useful amount, size, arrangement, and shape such as those well known in the ceramic heat exchanger, catalyst and filter art with examples being described by U.S. Pat. Nos. 4,304,585; 4,335,783; 4,642,210; 4,953,627; 5,914,187; 6,669,751; and 7,112,233; EP Pat. No. 1508355; 1508356; 1516659 and Japanese Patent Publ. No. 6-47620. The thickness of the walls may be any useful thickness such as described in the afore mentioned and U.S. Pat. No. 4,329,162. The wall flow filter body is also provided, with a smooth outer surface or skin which profile may be circular, elliptical or quadrangular, but the invention is not limited to any particular skin profile.

The wall flow filter may be any size suitable for the designated use to remove soot from as exhaust stream so that the exhaust exiting the exhaust system meets environmental standards. The size of the wall flow filter may vary depending on the size of the engine and defined operating conditions. The wall flow filter may have a diameter. The length of the wall flow filter may vary based upon the diameter of the particulate filter. For example, a longer wall flow filter may have a smaller diameter, a shorter particulate filter may have a larger diameter, or a combination thereof. The wall flow filter may have an end face. The end face area may be about 1500 cm² or less, about 1200 cm² or less, or about 1000 cm² or less. The end face area may be about 300 cm² or more, about 400 cm² or more, or about 500 cm² or more. The filter may have a volume in liters. The volume of the filter may be large enough so that the filter adequately removes contaminants from the exhaust stream. The ratio of the filter size to engine size may be any ratio that adequately removes contaminates from the exhaust stream.

The wall flow filter may be regenerated by an active regeneration cycle or a passive regeneration cycle. An active regeneration cycle occurs when fuel (e.g. diesel fuel) is injected into the exhaust system and the fuel ignites to heat the soot in the particulate filter so that the soot is converted into carbon dioxide, carbon monoxide, or both. A passive system occurs continuously during the running process of the diesel engine. For example, as nitrogen oxide (NOx) enters the particulate filter the soot in the diesel particulate filter may Oxidize by the NO₂ and convert the soot (e.g. carbon) into carbon dioxide, carbon monoxide, or both.

FIG. 1 illustrates a conventional honeycomb wall flow filter structure 100 with the symmetrical cross-sectional view of an inlet end face 103 and an outlet end face 104 (not visible), and an array of porous, walls 106 with thickness 107. The inlet channels 108 are plugged at the outlet end face 104 (not visible) and the outlet channels 110 are plugged at the inlet end face 102. The channels extend longitudinally between the inlet end face 102 and the outlet end face 104 and define symmetrical cross sectional matrix-like geometry that in this illustration has a pattern of a checker-board.

FIG. 2 illustrates an exemplary pictorial of a schematic fragmentary perspective view 200 taken within a body of a wall flow filter according to an embodiment of this invention. The fragment of the filter Structure 200 includes plurality of walls 210 extending mutually parallel to one another between the end face 212 and the end face 216 (not visible), and define a plurality of the inlet channels 220, and a plurality of the outlet channels 224. In contrast to the conventional honeycomb symmetrical filter structure shown in FIG. 1, FIG. 2 illustrates an example of asymmetrical matrix-like geometry showing different polygonal shapes, square and rhombus, of the cross-sectional perimeters of the inlet channels 220 and the outlet channels 224.

FIG. 3 illustrates an exemplary pictorial configuration of a schematic fragmentary cross-sectional view of the FIG. 2. The figure illustrates an end view of the end face 212 without the plugs depicting an example of asymmetrical matrix geometry showing different polygonal shapes, square and rhombus, of the cross-sectional perimeter of the inlet channels 220 and the mulct channels 224. The shadowed portions 228 and 230 show that inlet and outlet channels have four adjacent inlet and outlet channels, correspondingly. Each outlet channel 224 shares common walls with four inlet channels 220 and shares common corners with four outlet channels 224. Bach inlet channel 220 Shares common walls with four outlet channels 224 and shares common corners with four inlet channels 220. The figure illustrates that the inlet channels share wails in common only with the outlet channels, except at their points of contact 232, and that all the sides of the cross-sectional perimeter of both inlet and outlet channels are equal in length, 236.

FIG. 4 illustrates an enlarged cut-out 240 of FIG. 3 showing the inlet cross-sectional channel area 204, inlet perimeter length 260, the outlet channel cross-sectional area 206, the outlet perimeter length 270, and the acute angles 280 of the outlet cross-sectional perimeter.

FIG. 5 illustrates an exemplary schematic cross-sectional view showing another possible configuration of the matrix geometry of the wall flow filter according to an embodiment of these teachings. The figure shows an example of the filter fragment where for exemplary purposes the acute angle 280 is about 60 degrees. The shaded area represents the cross-sectional area of the inlet channel 204 and the non-shaded area represents the cross-sectional area of the outlet channel 206.

FIG. 6 illustrates an exemplary schematic cross-sectional view showing another possible configuration of the matrix geometry of the wall flow filter according to an embodiment of these teachings. The figure shows an example of the filter fragment, where for exemplary purposes the acute angle 280 is about 30 degrees. The shaded area represents the cress-sectional area of the inlet channel 204 and the non-shaded area represents tire cross-sectional area of the outlet channel 206.

FIG. 7 illustrates a result of the calculation of the ratio of the cross-sectional area of the inlet channel to the cross-sectional area of the outlet channel, and is plotted as a function of acute angle, expressed in degrees. The values of the ratio are summarized in Table 1

FIG. 8 illustrates a result of a calculation of the relative total filter volume and is plotted as a function of acute angle, expressed in degrees. The values of the ratio are summarized in Table 1. As shown in FIG. 7, the acute angle can be selected to set an exact ratio of the inlet to outlet channel cross-sectional areas. This infinite control is not possible in any of the prior art. It allows one to tailor the filter design for optimal performance by selecting any desired ratio of inlet to outlet channel areas. This ratio can be selected to balance filter capacity for ash and soot storage along with filter pressure drop. The optimum ratio can be determined and selected for each unique DPF application. As shown in FIG. 8, the relative total filter volume decreases as the acute angle decreases. It is apparent that the soot storage capacity remains the same while the filter can be downsized, because the outlet channel volume can be varied without changing the inlet channel volume. This invention has a combination of benefits that are not possible in the prior art, specifically an asymmetric channel design that allows infinite control in designing the inlet to outlet channel area ratio in order to optimize soot and ash storage, full utilization of the filter material (no walls shared by adjoining inlet channels), and identical perimeters for each inlet and outlet channel in the filter.

Parts by weight as used herein refers to 100 parts by weight, of the composition specifically referred to. Exemplary embodiments of the invention have been disclosed. A person of ordinary skill in the art recognizes, that modifications fall within the teachings of this application. Any numerical values recited in the above application include all values from the lower value to the upper value in increments of one unit provided that there is a separation of at least 2 units between any lower value and any higher value. All possible combinations of numerical values between the lowest value and the highest value enumerated are to be considered to be expressly stated in this application. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at feast me specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A honeycomb filter, comprising:
a plurality of internal walls defining a plurality of inlet channels and a plurality of outlet channels, wherein all of the internal walls are disposed between the inlet and outlet channels, wherein the internal walls define the cross-sectional perimeters of the inlet channels and the cross-sectional perimeters of the outlet channels;
the cross-sectional perimeters of the inlet channels have the shape of a polygon, wherein the cross-sectional perimeter has an inlet perimeter length;
the cross-sectional perimeters of each of the outlet channels have the shape of a polygon, wherein two pairs of internal walls form two opposite acute angles, wherein the cross-sectional area has an outlet perimeter length, and wherein a ratio of the cross sectional area of the inlet channels defined by the cross-sectional perimeters of the inlet channels to the cross-sectional area of the outlet channels defined by the cross-sectional perimeters of the outlet channels is greater than 1.0.

2. The honeycomb filter according to claim 1, wherein the inlet perimeter length is equal to the outlet perimeter length.

3. The honeycomb filter according to claim 1, wherein the cross-sectional perimeter of the inlet channels has four sides equal in length, and four angles equal to about 90 degrees.

4. The honeycomb filter according to claim 1, wherein the cross-sectional perimeter of the outlet channels has four sides equal in length.

5. The honeycomb filter according claim 1, wherein the acute angles of the cross-sectional perimeter of the outlet channel are preferably about 50 degrees or greater.

6. The honeycomb filter according to claim 1, wherein the acute angles of the cross-sectional perimeter of the outlet channel are from about 55 degrees to about 85 degrees.

7. The honeycomb filter according to claim 1, wherein the inlet channels and the outlet channels are arranged such that all the internal walls of the inlet channels are shared on common with the adjoining outlet channels.

8. The honeycomb filter according to claim 1, wherein the ratio of the cross-sectional area of the inlet channels to the cross-sectional area of the outlet channels is less than 2.0.

9. The honeycomb filter according to claim 1, wherein
a surface area of the inlet channels is defined as the inlet perimeter length multiplied by the length of the internal walls of the inlet channels in a longitudinal direction;
a surface area of the outlet channels is defined as the outlet perimeter length multiplied by the length of the internal walls of the outlet channels in the longitudinal direction; and
a ratio of the surface area of the inlet channels to the surface area of the outlet channels is about 1.0.

10. The honeycomb filter according to claim 1, wherein the length of the internal walls of the inlet channels and the length of the internal walls of the outlet channels is essentially of the same dimension in the longitudinal direction.

11. The honeycomb filter according to claim 1, wherein
a volume of the inlet channels is defined as the cross sectional area of the inlet channels multiplied by the length of the internal walls of the inlet channels in the longitudinal direction,
a volume of the outlet channels is defined as the cross section area of the outlet channels multiplied by the length of the internal walls of the outlet channels in the longitudinal direction; a relative total volume of the filter is defined as a ratio of V and Vₘₐₓ, wherein
(V) being a total volume defined by a sum of the volumes of all the inlet channels and the volumes of all the outlet channels,
(Vₘₐₓ) having a maximum value of the sum of the volumes of all the inlet channels and the maximum volumes of all the outlet channels; and
wherein the ratio is less than 1.0.

12. The honeycomb filter according to claim 1, wherein the ratio (V/Vₘₐₓ) is about 0.9 or less.

13. The honeycomb filter according to claim 1, wherein the internal walls of inlet and outlet channels further comprise fillets or chamfers.

14. The honeycomb filter according to claim 1, wherein the plurality of the inlet channels are placed adjacent and substantially parallel to the plurality of outlet channels in the longitudinal direction.

15. The honeycomb filter according to claim 1, wherein a number of the inlet channels and a number of the outlet channels is substantially the same.

16. The honeycomb filter according to claim 1, wherein the filter is useful as a diesel engine exhaust particulate filter.
